(19) United States
(12) Patent Application Publication
(10) Pub. No.: US 2013/0264074 A1
(43) Pub. Date: Oct. 10, 2013

(54) Method and Apparatus for Fire Suppression in Residential Attics and Basements

(71) Applicants: David B. Lewis, St. Louis, MO (US); Frank G. Speno, Glendale, MO (US)

(72) Inventors: David B. Lewis, St. Louis, MO (US); Frank G. Speno, Glendale, MO (US)

(21) Appl. No.: 13/610,340

(22) Filed: Sep. 11, 2012

Related U.S. Application Data
(60) Provisional application No. 61/620,778, filed on Apr. 5, 2012.

(51) Int. Cl. G08B 17/06; A62C 37/00; A62C 3/00

(52) U.S. Cl. 169/46; 169/9; 340/577

(57) ABSTRACT

A method and apparatus for suppressing fires in residential attics and basements. The components of one embodiment function in an integrated way so as to suppress residential attic and basement fires more safely and successfully than do traditional methods of the art of residential firefighting. Electronic messages from fire detection devices in residential attics and basements are processed so that a plurality of actions are performed in order to efficiently suppress fire in those residence spaces, thereby minimizing loss of human life and property. Actions include and are not limited to activation of emergency lighting in affected spaces, activation of surveillance camera devices to enable remote visual monitoring by responders, electronic notification of responders as to the existence and location of fire within the residence, alarm notification of occupants of the residence, and deployment of condensed aerosol agents to suppress or extinguish the residential attic or basement fire.

### CROSS-REFERENCE TO RELATED APPLICATIONS

This application claims the benefit of provisional patent application No. 61/620,778 filed on 2012 Apr. 5, which is incorporated by reference.

### BACKGROUND OF THE INVENTION

1. Field of the Invention

This invention pertains generally to the art of detecting and suppressing fires in residential attics and basements. More specifically, the present invention relates to a fire suppression method and apparatus that meet the particular requirements for successfully fighting and suppressing fires in residential attics and basements.

2. Description of the Related Art

In recent years, an average of 18,700 building fires originating in residential attics, basements and other heating areas have been reported annually by U.S. fire departments. Fires in residential attics and basements are particularly dangerous and costly types of residential fires, accounting for substantial property loss in addition to deaths and injuries of building occupants and responders. By far, the leading factor contributing to the ignition of residential attic fires is electrical failure or malfunction resulting in short-circuit electrical arcing. Lightning strikes are also a prominent factor. Once ignited, attic fires often go unnoticed in their early stages, enabling them to become larger and to involve more of the building structure before detection. Because attics provide an array of fuel sources, so that fire spreads quickly while remaining concealed, almost all residential attic fires become nonconfined fires, spreading beyond their originating area to other areas of the building. One third of residential attic fires ultimately involve and severely damage or completely destroy the entire residence.

Fires in residential basements and other heating areas present other challenges. The presence of stored combustible materials in proximity to heating equipment in basement spaces is the leading specific factor contributing to ignition of fire in those spaces, followed by mechanical failure or malfunction of heating and other electrical equipment. Further, the flammable properties of fuels often used in residential heating, e.g., heating oil and natural gas used in furnaces and water heating devices, also factor into the risk profile of residential basement fires.

Because of the nature of these building spaces, residential attic and basement fires pose hazards and difficulties for firefighters and other responders that go beyond those encountered in other types of residential fires. Attic construction in one- and two-family residential buildings, which account for ninety percent of residential attic fires, is such that wood framing and structural members provide a continuous open space, enabling fire to spread quickly to the full length and width of the building. In addition, newer residences typically employ a truss-framed construction involving wood boards running between the attic ceiling and floor, inhibiting movement throughout the attic. Further, attic access in most residences is quite limited in terms of location of access panels within the residence, manner of access and size of access openings. Finally, many residential attics have very limited areas built with load-bearing flooring. Thus, firefighters who enter the attic space in attacking a fire are faced with challenges in reaching and getting equipment to the fire, in confronting the fire across multiple locations of the attic, and in navigating safely through the attic space.

Residential basement construction presents similar hazards in terms of continuous open space, enabling fire to quickly ignite wood joists across large portions of the building. Access to residential basements, like attics, is often limited and may pose challenges in getting necessary equipment in place to attack fire and in maintaining open pathways for emergency egress by firefighters. Additionally, ignitable fuels and stored combustibles often found in residential basement spaces are particularly hazardous aspects of these fires.

In addition to the particularly dangerous nature of residential attic and basement fires, these fires are also costly in terms of property loss. Residential attic fires result in more than double the dollar loss per fire than do fires in non-attic residential spaces. This difference owes in part to the challenges noted above in the detection and suppression of these fires. Water damage due to firefighting also plays heavily into the high dollar loss per fire of residential attic fires. Because attic fires are attacked at the highest level of the building structure, water damage extends beyond the attic to the occupied floors below, often resulting in damages and dollar losses to those floors exceeding damages and dollar losses to the attic itself. Residential basement fires classified as nonconfined, i.e., extending to areas of the building beyond the area of ignition, result in dollar losses per fire that are 75% higher than average dollar losses per fire for residential building fires overall.

Traditionally, water has been the fire suppression agent employed in fighting residential attic and basement fires. Water can be delivered to the site of a residential fire either from automatic extinguishing systems, i.e., sprinklers, or via firefighters' hoses. Regarding attic sprinklers, none of the national model codes require sprinklers in attics in one- and two-family residences, the location of ninety percent of attic fires. Additionally, the fact that the liquid and conductive properties of water can cause substantial collateral property loss to lower floors when water is used for fire suppression in an attic means that property owners are hesitant to install attic sprinklers. It is not surprising that attic sprinklers are present in just one percent of residential attic fires reported annually by U.S. fire departments. Use of water delivered via firefighters' hoses to fight residential attic fires gives rise to these same issues of collateral property damage to lower floors. Additionally, because hose access to residential attics is often difficult, requiring long hose runs to upper floors and through access panels that may be problematic in location and limited in size, the time required for firefighters to set up and attack attic fire with this method is often too long to prevent extensive damage or total involvement and loss of the building.

Residential basement sprinklers are present in only two percent of nonconfined basement and heating area fires reported. The use of water-delivering sprinklers in a basement environment where electrical heating and other equipment, ignitable fuels and various stored combustibles may be present is a topic of discussion in the firefighting community. Also, as with attic fires, issues of limited basement access and hose setup time for firefighters present drawbacks to the use of water delivered via firefighters' hoses as the primary fire suppression method for residential basement fires.

The use of water as the primary suppression agent for these residential fires is suboptimal as noted above. While several fire suppression systems are known that deploy suppression agents other than water, none has addressed the particular human safety issues and logistical problems associated with fighting and suppressing fire in residential attics and basements.

In both attic fires and basement fires in residences, speed in attacking and suppressing the fire is particularly important, given the rate of fire spread in attic fires and the presence of combustibles in residential basements. The time from ignition to detection to arrival and set up of firefighters on the scene to commencement of attack is often too long to prevent loss of life and injury and to save the residence from severe damage or total loss.

Given the dangerous and costly nature of residential attic and basement fires, it would be advantageous if a method and apparatus for suppression of these residential fires could significantly shorten the time between fire ignition and successful fire extinguishment. Such a method and apparatus would enable remote real-time visual monitoring of the affected spaces by home security providers and responders en route to and at the residence, thereby ensuring a more effective and safer response. Additionally, the method and apparatus would provide alarm notification of occupants and others in the vicinity of the residence of the specific location of the fire within the residential attic or basement, thereby enabling those persons to make a more informed and safer response. Further, the method and apparatus would deploy non-toxic and ecologically-safe condensed aerosol agents, rather than water, to suppress and extinguish the residential fire, thereby shortening the period of time between ignition and suppression and minimizing loss of human life and property.

It should be apparent that there is a need for a method and apparatus for fire suppression in residential attics and basements that greatly improves the outcome profile of these residential fires. The present invention fulfills this need. Other problems with the prior art not described above can also be overcome using the teachings of the present invention, as would be readily apparent to one of ordinary skill in the art of residential firefighting after reading this disclosure.

### SUMMARY

In accordance with embodiments of the invention, one or more electronic fire detection devices of various types are made to be present in a residential attic or basement space. One type of these devices employs electronic heat detectors equipped with self-restoring normally-open contacts. When a predetermined temperature in the attic or basement space is reached, indicating presence of fire, these contacts close, sending an electronic message to a system processor. Another type of these devices, commonly known as ionization type, employs a radioactive element. When a sufficient concentration of smoke is detected, this type of these devices indicates its presence and sends an electronic message to the system processor. A third type of these devices observes the visible, infrared or ultraviolet spectra and detects the observable characteristics of heat or flame. This type of these devices detects heat or flame, and sends an electronic message to the system processor. Upon receipt by the system processor of such an electronic message indicating the detection of fire, the message is processed and a plurality of actions is initiated according to specified rules. The availability of these types of electronic fire detection devices enables the system processor to perform algorithms that minimize false alarms.

In one aspect, when the system processor receives electronic messages alerting it of fire, it sends an electronic message to audible alarm devices that are made to be present throughout the residential structure. Upon receipt by the audible alarm devices of such an electronic message, the alarm devices are activated, alerting occupants in all areas of the residence to the presence of fire in the attic or basement space. In another aspect, an electronic message is sent by the system processor to one or more emergency lighting devices that are made to be present in the residential attic or basement space in which the presence of fire has been detected. Upon receipt by the emergency lighting devices of such an electronic message, the emergency lighting devices are activated. In another aspect, an electronic message is sent to the system processor by one or more surveillance camera devices that are made to be present in the residential attic or basement space in which the presence of fire has been detected. The surveillance camera devices provide images of the affected space to enable remote visual monitoring by home security providers and responders. The visual images are correlated to the physical orientation of the residential attic or basement space, are time stamped, and are temporarily stored by the system processor such that the actual ignition and spread of fire can be observed. In another aspect, an electronic message is sent by the system processor to one or more pre-discharge alarm devices that are made to be present in the affected residential attic or basement space. Upon receipt by the pre-discharge alarm devices of such an electronic message, the alarm devices are activated to give any individuals located in the affected space positive notification of impending discharge of non-toxic fire suppression agents. In another aspect, an electronic message is sent by the system processor to one or more condensed aerosol deployment devices that are made to be present in the residential attic or basement space in which presence of fire has been detected. These devices are electronically interconnected, and each device is equipped with an electric initiator. Upon receipt by the electric initiators in the condensed aerosol deployment devices of such an electronic message, the devices are activated and create and discharge particulates of condensed aerosol into the affected residential attic or basement space, thereby flooding the space with non-toxic suppression agent with the objective of rapidly suppressing and extinguishing fire. In yet another aspect, an electronic message is sent by the system processor to a communications device made to be present in the residential building. Upon receipt by the communications device of such an electronic message, the communications device initiates electronic notification of home security providers, firefighters and other responders of the existence and location of fire within the residence, e.g., attic or basement, and the fact that non-toxic condensed aerosol fire suppression agents are deployed in the affected spaces. In addition to these actions initiated upon the detection of fire, a status reporting device provides continuous status indicators to building occupants, including key indicators such as emergency power supply status and time to necessary maintenance and system tests.

A rules engine defines the system processor operational modes. The rules engine is programmable via installation, configuration and testing tools, by which the means of operation can be tailored for specific buildings, fire detection strategies, and fire suppression strategies.

The components of the present invention thus function in an integrated way so as to suppress residential attic and basement fires much more safely and successfully than do the traditional methods of the art of residential firefighting. In homes in which the present invention is installed, attic and basement fires may be successfully suppressed or extinguished before firefighters are able to arrive upon the scene. Once firefighters do arrive upon the scene, they are fully aware of the fire situation because of the inclusion of surveillance camera devices among the components. Firefighters can more safely and more successfully approach and address the fire situation, thereby reducing injuries and loss of life both to firefighters and other responders and to occupants of the affected residence. None of the prior art fire suppression methods and more effectively and safely respond.

Another advantage of the present invention is the provision of a communications device including a data communications interface compatible with leading home security providers and local responders. The system processor can thereby initiate electronic notification of the detection of fire and its location within the residence, and can make responders aware of the fact that non-toxic condensed aerosol fire suppression agents are deployed in the affected spaces. Responders arrive on the scene of the fire with a more complete understanding of the situation and the required response.

An additional advantage of the present invention is the provision of tools for rapid installation, configuration and testing of the invention by homeowners and installers, thereby increasing affordability by minimizing total cost of ownership. These tools include devices for use in calculating volume of the attic or basement space, instructional videos available to hand-held devices via internet connection, and two-way live visual installation and testing support also available via internet connection. Homeowners and installers can thereby quickly and correctly install the invention, enter configuration parameters to the configuration file and test the installed invention before placing it into operation.

Yet another advantage of the present invention is the provision of an emergency power supply for powering the system processor and other components of the present invention during a power outage in the residence.

A further advantage of the present invention is the incorporation of a heat-resistant shield into the design of the condensed aerosol deployment device that discharges fire suppressant into the affected residential attic or basement. Wood frame construction is employed in the vast majority of homes, and the aerosol deployment device is typically attached to wooden rafters or trusses found in attics and joists in basements. The heat-resistant shield is therefore an important design feature in the present invention, as it protects the structural member to which the device is affixed from the increased temperature of the device that occurs when the device is activated.

Other features and advantages of the present invention should be apparent from the following description of the preferred embodiment, which illustrates, by way of example, the principles of the invention.

### BRIEF DESCRIPTION OF THE DRAWINGS

The invention may take physical form in certain parts and arrangements of parts a preferred embodiment of which is described in detail in this specification and illustrated in the accompanying drawings which form a part hereof and wherein:

FIG. 1 is a block diagram that shows a method and apparatus for fire suppression in a residential attic or basement 100.

FIG. 2 is a block diagram that shows components of the FIG. 1 system processor 106.

FIG. 3 is a representative floor plan diagram of a residential attic space with components of the present invention for the suppression of residential attic fire 300.

FIG. 4 is a representative floor plan diagram of a residential basement space with components of the present invention for the suppression of residential basement fire 400.

FIG. 5 is a side exterior view of a condensed aerosol deployment device 116 for creating and discharging particulates of condensed aerosol into the affected residential attic or basement space, incorporating a heat-resistant shield 512 into the design of the device.

### DETAILED DESCRIPTION

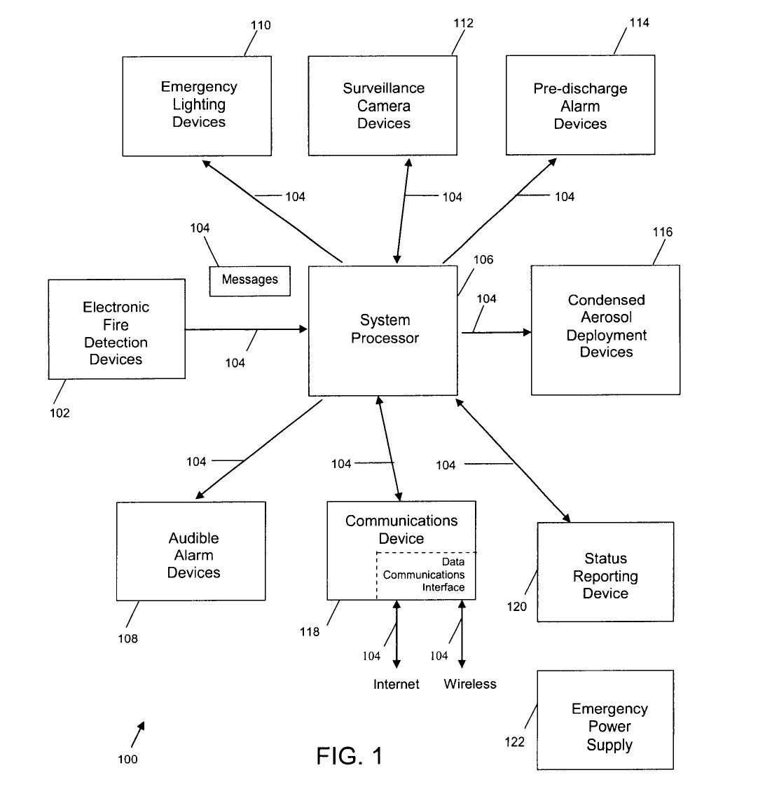

FIG. 1 is a block diagram representation of a method and apparatus for fire suppression in a residential attic or basement 100. FIG. 1 shows that the system includes electronic fire detection devices 102 that, upon the detection of fire, send an electronic message 104 to a system processor 106 for processing. The system processor 106 receives that message and initiates a plurality of actions according to pre-specified rules. In the FIG. 1 illustrated embodiment, actions include: sending an electronic message 104 from the system processor 106 to audible alarm devices 108 in the building, thereby activating those devices and alerting occupants of the residence and nearby individuals that fire has been detected in the attic or basement space; sending an electronic message 104 from the system processor 106 to emergency lighting devices 110 in the residential attic or basement space where fire has been detected, thereby activating those lighting devices; sending an electronic message 104 from the surveillance camera devices 112 in the residential attic or basement space where fire has been detected to the system processor 106, thereby obtaining images from those surveillance camera devices; sending an electronic message 104 from the system processor 106 to pre-discharge alarm devices 114 in the affected attic or basement, thereby activating the pre-discharge alarm devices and notifying any individuals located in the affected space of the impending discharge of non-toxic fire suppression agents; sending an electronic message 104 from the system processor 106 to condensed aerosol deployment devices 116 in the affected attic or basement, thereby activating those devices and flooding the space with non-toxic and ecologically-safe condensed aerosol fire suppression agent; sending an electronic message 104 from the system processor 106 to a communications device 118 including a data communications interface, thereby initiating notification by the device of firefighters and other responders of the existence and location of fire within the residential attic or basement, and the fact that condensed aerosol fire suppression agents are deployed in the affected spaces. FIG. 1 also shows that the system processor 106 sends electronic messages 104 to a system status reporting device 120, thereby providing continuous indicators of system status. Further, FIG. 1 shows that the present invention includes an emergency power supply 122 for powering the system components during a power outage in the residence.

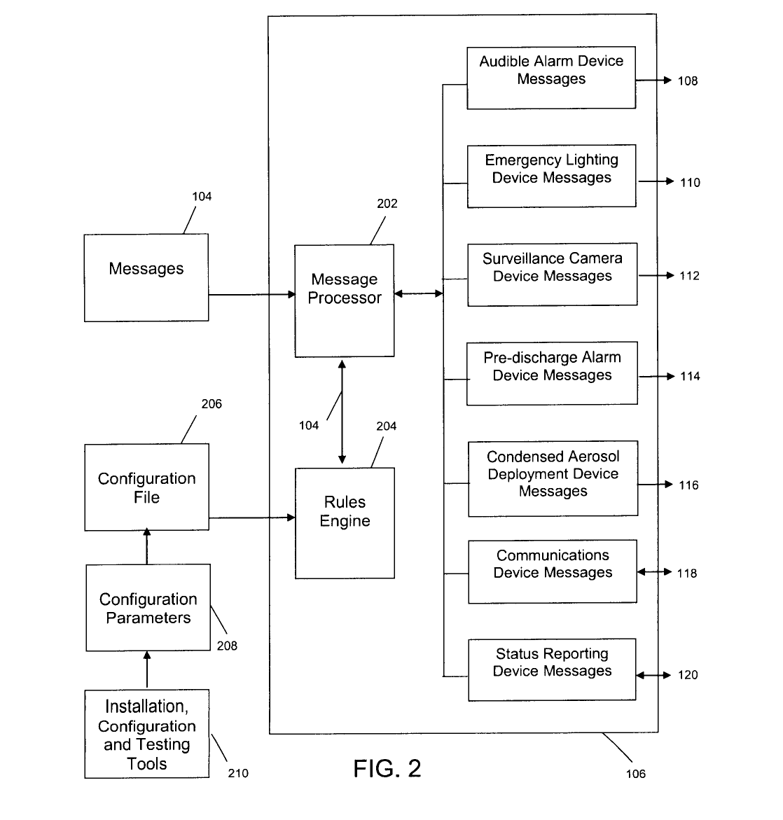

FIG. 2 is a block diagram that shows components of the system processor 106. FIG. 2 shows that the system processor 106 includes among other components a message processor 202 and a rules engine 204. Electronic messages 104 are received at the message processor 202 and are processed in conjunction with the rules engine 204. In order to determine the specific plurality of actions to be initiated, the rules engine 204 receives rules from a configuration file 206 that holds a collection of system configuration parameters 208 that may be determined with installation, configuration and testing tools 210 at system installation and setup. Once the electronic messages 104 have been received and processed, actions are initiated by the system processor 106, and electronic messages 104 are interchanged with system devices including but not limited to audible alarm devices 108, emergency lighting devices 110, surveillance camera devices 112, pre-discharge alarm devices 114, condensed aerosol deployment devices 116, a communications device 118, and a system status reporting device 120.

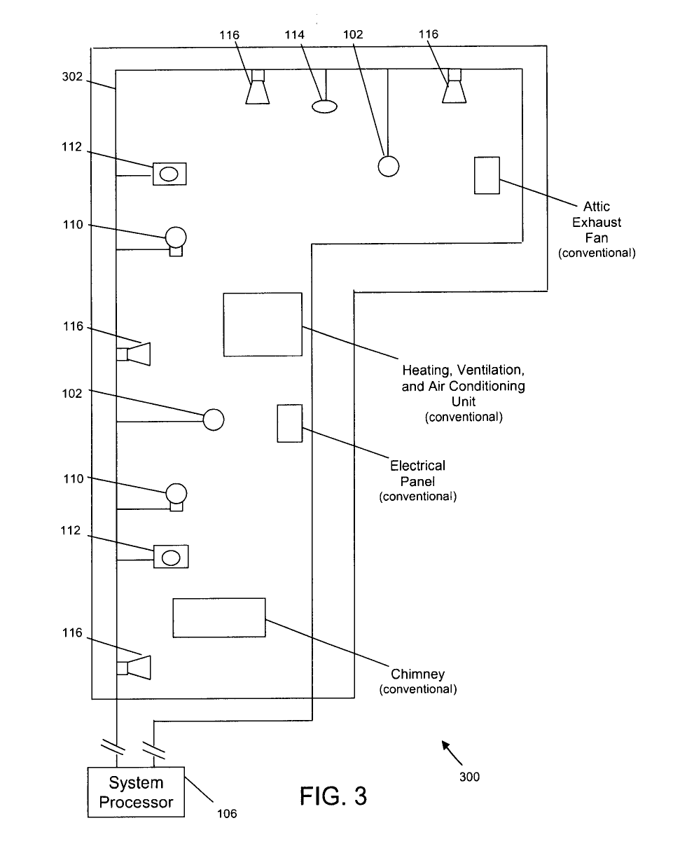

FIG. 3 is a representative floor plan diagram of a residential attic space with components of the present invention for the suppression of residential attic fire 300. FIG. 3 shows the positioning of electronic fire detection devices 102 and emergency lighting devices 110 in the attic space. FIG. 3 also shows the positioning of surveillance camera devices 112 in the attic space. It should be noted that particular placement of the surveillance camera devices 112 is based upon factors including but not limited to the overall size and configuration of the attic space and the visual coverage area of each device. Attic size and configuration considerations include, for example, the length, width and physical layout of the attic, and the visual sight lines available at various positions in the attic. The visual coverage area of each device is specified at the time of manufacture. The objective in placement of the surveillance camera devices 112 is to ensure that, when activated, they together will provide home security providers, firefighters and other responders a complete real-time view of the fire condition in the residential attic. FIG. 3 also shows the positioning of a pre-discharge alarm device 114 in the attic space. FIG. 3 further shows the positioning of condensed aerosol deployment devices 116 at intervals in the attic space. It should be noted that particular placement of these devices is based upon factors including but not limited to the overall configuration of the attic space, the volume of the attic space, and the volume coverage of each device. Attic configuration considerations include, for example, the length, width and physical layout of the attic, as well as the presence and placement in the attic of objects such as heating, ventilation, and air conditioning units, electrical panels, chimneys, attic exhaust fans, and other objects that merit particular consideration in placement of condensed aerosol deployment devices 116. The volume of the attic space is calculated according to the appropriate mathematical formulae for computation of volume of a space. The volume coverage of each device is specified at time of manufacture. The objective in placement of the condensed aerosol deployment devices 116 is to ensure that, when activated, they together will adequately flood the residential attic space with non-toxic and ecologically-safe condensed aerosol suppression agent, so as to rapidly and effectively suppress or extinguish fire. FIG. 3 also shows that the electronic fire detection devices 102 are electronically connected to the system processor 106 via electrical cabling 302 or wireless connection, in order to send to the system processor 106 electronic messages indicating the detection of the existence of fire. FIG. 3 further shows that the emergency lighting devices 110, the surveillance camera devices 112, the pre-discharge alarm device 114, and the condensed aerosol deployment devices 116 are electronically connected to the system processor 106 via electrical cabling 302 or wireless connection, in order to interchange with the system processor 106 electronic messages that will activate the devices.

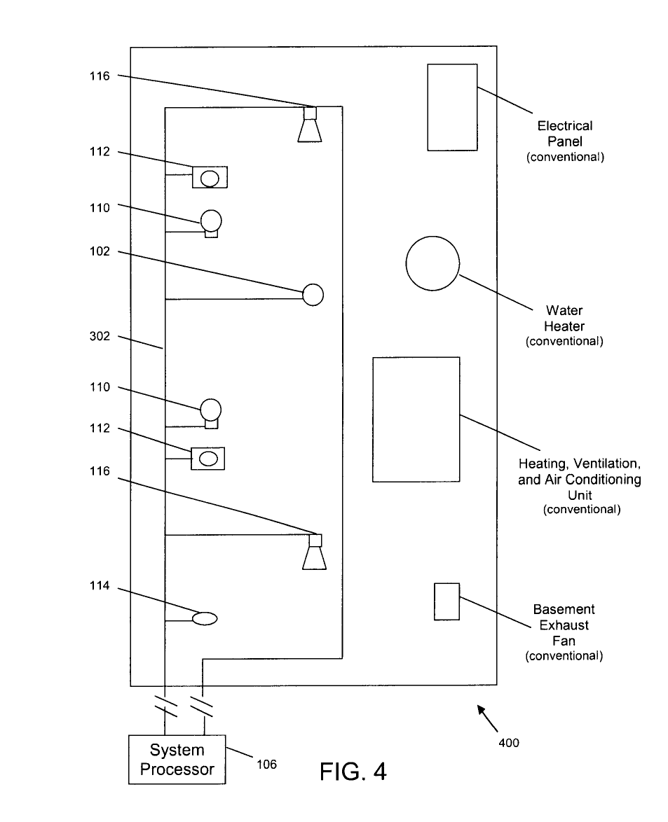

FIG. 4 is a representative floor plan diagram of a residential basement space with components of the present invention for the suppression of residential basement fire 400. FIG. 4 shows the positioning of electronic fire detection devices 102 and emergency lighting devices 110 in the basement space. FIG. 4 also shows the positioning of surveillance camera devices 112 in the basement space. It should be noted that particular placement of the surveillance camera devices 112 is based upon factors including but not limited to the overall size and configuration of the basement space and the visual coverage area of each device. Basement size and configuration considerations include, for example, the length, width and physical layout of the basement, and the visual sight lines available at various positions in the basement. Visual coverage area of each device is specified at the time of manufacture. The objective in placement of the surveillance camera devices 112 is to ensure that, when activated, they together will provide home security providers, firefighters and other responders a complete real-time view of the fire condition in the residential basement. FIG. 4 also shows the positioning of a pre-discharge alarm device 114 in the basement space. FIG. 4 further shows the positioning of condensed aerosol deployment devices 116 at intervals in the basement space. It should be noted that particular placement of these devices is based upon factors including but not limited to the overall configuration of the basement space, the volume of the basement space, and the volume coverage of each device. Basement configuration considerations include, for example, the length, width and physical layout of the basement, as well as the presence and placement in the basement of objects such as heating, ventilation, and air conditioning units, electrical panels, water heaters, basement exhaust fans, and other objects that merit particular consideration in placement of condensed aerosol deployment devices 116. The volume of the basement space is calculated according to the appropriate mathematical formulae for computation of volume of a space. The volume coverage of each device is specified at the time of manufacture. The objective in placement of the condensed aerosol deployment devices 116 is to ensure that, when activated, they together will adequately flood the residential basement space with non-toxic and ecologically-safe condensed aerosol suppression agent, so as to rapidly and effectively suppress or extinguish fire. FIG. 4 also shows that the electronic fire detection devices 102 are electronically connected to the system processor 106 via electrical cabling 302 or wireless connection, in order to send to the system processor 106 electronic messages indicating the detection of the existence of fire. FIG. 4 further shows that the emergency lighting devices 110, the surveillance camera devices 112, the pre-discharge alarm device 114, and the condensed aerosol deployment devices 116 are electronically connected to the system processor 106 via electrical cabling 302 or wireless connection, in order to interchange with the system processor 106 electronic messages that will activate the devices.

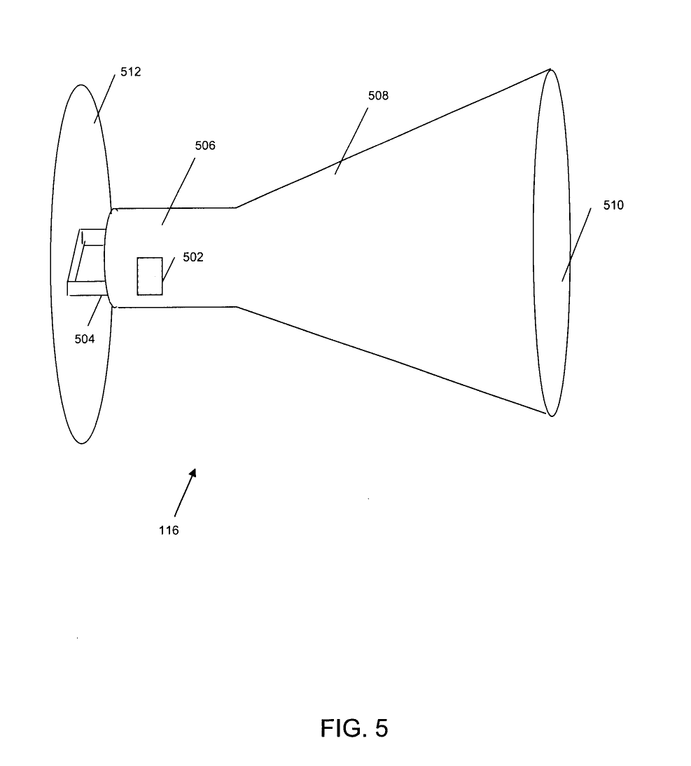

FIG. 5 is a side exterior view of a condensed aerosol deployment device 116 for creating and discharging particulates of condensed aerosol into an affected residential attic or basement space, incorporating a heat-resistant shield 512 into the design of the device in order to protect the residential attic or basement structure to which the device is affixed from increased temperature of the device during thermal decomposition of the aerosol-forming compound stored within the device. The objective of the device is to flood the affected space with non-toxic and ecologically-safe condensed aerosol fire suppression agent in order to rapidly suppress and extinguish fire. FIG. 5 shows the structure of the device including points of electrical interconnection 502 with other such devices installed in a residential attic or basement space and of connection with the system processor, a bracket 504 for affixing the device to a residential attic or basement structure, space within the device for an electric initiator 506, space within the device for storage of a solid aerosol-forming compound 508, one or more ports 510 for discharging condensed aerosol particulates upon activation of the device and thermal decomposition of the stored compound, and a heat-resistant shield 512 for protecting the residential attic or basement structure to which the device is affixed from increased temperature of the device during thermal decomposition of the stored compound.

Thus, the invention provides a method and apparatus for fire suppression in residential attics and basements, thereby minimizing loss of human life and injuries as well as damage to and loss of property from these fires.

The present invention has been described above in terms of a presently preferred embodiment so that an understanding of the present invention can be conveyed. There are, however, many configurations not specifically described herein but with which the present invention is applicable. The present invention should therefore not be seen as limited to the particular embodiments described herein, but rather, it should be understood that the present invention has wide applicability with respect to suppression of fires in residential spaces generally. All modifications, variations, or equivalent arrangements and implementations that are within the scope of the attached claims should therefore be considered within the scope of the invention.

We claim:

1. A method for detecting and suppressing fire in a residential attic or basement, the method comprising:
detecting said fire;
providing notification and images of said fire in said residential attic or basement to occupants, home security providers or local responders; and
deploying fire suppression agents in said residential attic or basement;
whereby said fire can be suppressed or extinguished more successfully and with less damage and risk than with residential firefighting prior art.

2. A method as defined in claim 1, wherein detecting said fire comprises:
receiving by a system processor of electronic messages from a plurality of electronic fire detection devices comprising thermal, ionization or optical electronic fire detection devices;
whereby the speed and reliability of detecting said fire is improved relative to the independent use of said electronic fire detection devices.

3. A method as defined in claim 1, wherein providing said notification comprises:
alerting said occupants by activating a plurality of alarm devices positioned within said residential attic or basement or within an occupied area at risk because of proximity to said residential attic or basement both prior to and at the time of deploying of said fire suppression agents;
notifying said home security providers or local responders by activating a communications device and initiation by the device via a data communications interface of the notification of said home security providers or local responders;
whereby information regarding the presence of said fire in said residential attic or basement can be used to protect human life and property more effectively than with residential firefighting prior art.

4. A method as defined in claim 1, wherein providing said images comprises:
activating a plurality of emergency lighting devices positioned in said residential attic or basement;
activating a plurality of surveillance camera devices operating at a plurality of wavelengths in the visual, ultraviolet or infrared ranges positioned in said residential attic or basement;
associating the orientation of said surveillance camera devices images with the physical orientation of said residential attic or basement;
recording time-stamped output of said surveillance camera devices for a period prior to and subsequent to detecting said fire;
transmitting said images via interne connection or wireless connection;
receiving said images by said occupants, home security providers or local responders;
receiving said images on a remote workstation by said home security providers; and
receiving said images on a hand-held or other mobile device by said local responders en route to and at the scene of said fire;
whereby said occupants, home security providers or local responders can actually observe the time and location of initiation source and rate of spread of said fire in said residential attic or basement, and can respond more quickly, more effectively and more safely than with residential firefighting prior art.

5. A method as defined in claim 1, wherein deploying said fire suppression agents in said residential attic or basement comprises:
activating a plurality of condensed aerosol deployment devices positioned in said residential attic or basement;
creating and discharging by said condensed aerosol deployment devices particulates of non-toxic and ecologically-safe condensed aerosol fire suppression agent into said residential attic or basement; and
flooding by said condensed aerosol deployment devices of said residential attic or basement with said particulates;
whereby the resulting structural damage and risk to said occupants or said local responders resulting from said fire in said residential attic or basement is greatly reduced vis-à-vis residential firefighting prior art.

6. An apparatus for communicating and processing electronic messages pertaining to the detection and suppression of fire in a residential attic or basement and acting upon said electronic messages, the apparatus comprising:
a plurality of devices that communicate said electronic messages relating to said detection of fire in said residential attic or basement;
a system processor that processes said electronic messages and that communicates a plurality of electronic messages with a plurality of devices;
a rules engine that provides configuration parameters for use in processing said electronic messages in conjunction with said system processor;
devices that communicate said electronic messages with said system processor and that initiate a plurality of actions appropriate to said suppression of fire in a residential attic or basement;
an emergency power supply comprising storage means for electrical power sufficient to allow operation of said apparatus in the event grid power is interrupted and a means for detecting grid power interruption and switching to said storage means;
whereby said fire in said residential attic or basement can be suppressed or extinguished much more successfully than with residential firefighting prior art.

7. An apparatus as defined in claim 6, wherein said plurality of devices with which said system processor communicates said electronic messages regarding said detection of fire is selected from the group consisting of thermal, ionization and optical electronic fire detection devices in said residential attic or basement.

8. An apparatus as defined in claim 6, wherein said plurality of devices with which said system processor communicates said plurality of electronic messages includes audible alarm devices positioned within said residential attic or basement or within an occupied area at risk because of proximity to said residential attic or basement.

9. An apparatus as defined in claim 6, wherein said plurality of devices with which said system processor communicates said plurality of electronic messages includes emergency lighting devices in said residential attic or basement or within an occupied area at risk because of proximity to said residential attic or basement.

10. An apparatus as defined in claim 6, wherein said plurality of devices with which said system processor communicates said plurality of electronic messages includes electronic surveillance camera devices in said residential attic or basement.

11. An apparatus as defined in claim 6, wherein said plurality of devices with which said system processor communicates said plurality of electronic messages includes pre-discharge alarm devices in said residential attic or basement.

12. An apparatus as defined in claim 6, wherein said plurality of devices with which said system processor communicates said plurality of electronic messages includes condensed aerosol deployment devices that include an electric initiator in said residential attic or basement.

13. An apparatus as defined in claim 6, wherein said plurality of devices with which said system processor communicates said plurality of electronic messages includes a communications device.

14. An apparatus as defined in claim 6, wherein said plurality of devices with which said system processor communicates said plurality of electronic messages includes a status reporting device.

15. An apparatus as defined in claim 6, wherein said rules engine references a configuration file containing said configuration parameters.

16. An apparatus as defined in claim 15, wherein said configuration parameters are determined at system installation with use of installation, configuration and testing tools selected from the group consisting of tools for use in calculating volume of said residential attic or basement, instructional videos available to hand-held devices via internet connection, and two-way live visual installation and testing support available to hand-held devices via internet connection.

17. An apparatus as defined in claim 6, wherein said system processor communicates said plurality of electronic messages with said plurality of devices via electrical cabling or wireless connection.

18. An apparatus as defined in claim 6, wherein said plurality of actions initiated by said plurality of devices includes activation of audible alarm devices to alert occupants to said detection of fire.

19. An apparatus as defined in claim 6, wherein said plurality of actions initiated by said plurality of devices includes activation of emergency lighting devices in said residential attic or basement to assist occupants or local responders located in said residential attic or basement and to enable remote visual image monitoring.

20. An apparatus as defined in claim 6, wherein said plurality of actions initiated by said plurality of devices includes activation of electronic surveillance camera devices to enable remote image monitoring.

21. An apparatus as defined in claim 6, wherein said plurality of actions initiated by said plurality of devices includes activation of pre-discharge alarm devices to alert individuals to the impending discharge of non-toxic condensed aerosol fire suppression agent.

22. An apparatus as defined in claim 6, wherein said plurality of actions initiated by said plurality of devices includes activation of condensed aerosol deployment devices to create and discharge particulates of non-toxic condensed aerosol fire suppression agent.

23. An apparatus as defined in claim 6, wherein said plurality of actions initiated by said plurality of devices includes activation of a communications device to notify home security providers or local responders.

24. An apparatus for protecting structure in a residential attic or basement to which condensed aerosol deployment devices are affixed from high temperature said condensed aerosol deployment devices generate during operation, the apparatus comprising heat-resistant shields.
